(19) United States
(12) Patent Application Publication
(10) Pub. No.: US 2026/0018716 A1
(43) Pub. Date: Jan. 15, 2026

(54) Secondary Battery

(71) Applicant: LG Energy Solution, Ltd., Seoul (KR)

(72) Inventors: Hyun Jin Kim, Daejeon (KR); Yeon Hwa Wi, Daejeon (KR); Chang Ho Kim, Daejeon (KR); Seon UK Kim, Daejeon (KR); Jae Min Kim, Daejeon (KR)

(73) Assignee: LG Energy Solution, Ltd., Seoul (KR)

(21) Appl. No.: 19/327,516

(22) Filed: Sep. 12, 2025

Related U.S. Application Data
(63) Continuation of application No. 18/380,014, filed on Oct. 13, 2023.

(30) Foreign Application Priority Data
Oct. 14, 2022 (KR) 10-2022-0132745

(51) Int. Cl. H01M 50/14; H01M 50/105; H01M 50/126

(52) U.S. Cl. CPC H01M 50/14; H01M 50/105; H01M 50/126

(57) ABSTRACT

A secondary battery having improved impact resistance is provided. The secondary battery includes a battery case comprising an electrode assembly and an electrolyte accommodated in an accommodation part of the battery case. The secondary battery satisfies following Equation (1): Equation (1): W/S≤42. In Equation (1), W is an amount of electrolyte per unit capacity of the secondary battery [unit: g/Ah], and S is a product of a total length [unit: m] and a full width [unit: m] of the electrode assembly.

### CROSS-REFERENCE TO RELATED APPLICATIONS

The present application is a continuation of United States patent application Ser. No. 18/380, 014, filed on Oct. 13, 2023, which claims the priority of Korean Patent Application No. 10-2022-0132745, filed on Oct. 14, 2022, in the Korean Intellectual Property Office, the disclosure of which is incorporated herein by reference.

### BACKGROUND OF THE INVENTION

### Field of the Invention

The present invention relates to a secondary battery, and more particularly, to a secondary battery having excellent impact resistance.

### Description of the Related Art

Lithium secondary batteries are often manufactured by applying electrode active material slurry to positive electrode collectors and negative electrode collectors to manufacture positive electrodes and negative electrodes. The positive electrodes and the negative electrodes are then stacked on both sides of a separator to form an electrode assembly. Next, the electrode assembly is accommodated in a case, and an electrolyte is injected into the case.

Traditionally, secondary batteries have been classified according to a shape of the case accommodating the electrode assembly. Example secondary batteries include pouch-type secondary batteries, can-type secondary batteries, and prismatic-type secondary batteries. For example, pouch-type secondary batteries are manufactured by pressing a flexible pouch film to form a cup part into which an electrode assembly is accommodated, before the pouch is sealed and an electrolyte is injected. Can-type secondaries, on the other hand, are manufactured by accommodating an electrode assembly into a can made of a metal material provided with a top cap to seal the can, and injecting an electrolyte material into the sealed can.

While pouch-type secondary batteries are light weight, exhibit excellent space utilization, and have high energy densities due to their stacked electrode assemblies, they are more vulnerable to fire, explosion, and electrolyte leakage upon external impact compared to can-type secondary batteries.

Secondary batteries are used in a wide variety of products including electric vehicles to reduce and/or prevent greenhouse gas emissions. When secondary batteries are used in electric vehicles, such batteries are required to have excellent safety to protect passengers. Therefore, there is a desire to improve impact resistance of pouch-type secondary batteries.

### SUMMARY

An aspect of the present disclosure provides a secondary battery in which a size of an electrode assembly and an amount of electrolyte per unit capacity satisfy specific conditions to increase frictional force between the electrode assembly and a battery case (e.g., pouch), thereby suppressing separation of the electrode assembly and/or leakage of the electrolyte when an external impact is applied.

According to an aspect of the present disclosure, a secondary battery includes a battery case defining an accommodation part accommodating an electrode assembly and an electrolyte therein. The secondary battery satisfies following Equation (1):

$$W / S \leq 42 , \qquad Equation ( 1 )$$

where, in Equation (1), W is a weight of electrolyte per unit capacity of the secondary battery [unit: g/Ah], and S is a product of a total length [unit: m] and a full width [unit: m] of the electrode assembly.

Unless indicated otherwise, the capacity of the secondary battery may be defined by a rated capacity of the secondary battery. The secondary battery may have a rated capacity of 50 Ah to 200 Ah, preferably 50 Ah to 150 Ah, and more preferably 60 Ah to 140 Ah. The expression of a rated capacity of a secondary battery means the electric capacity generated when a fully charged battery is continuously discharged at 0.33C to the discharge end voltage. At this time, the full charge voltage (charge end voltage) and discharge end voltage may be appropriately selected depending on the type of secondary battery. For example, when the secondary battery is an NCM cell, the rated capacity may be the discharge capacity when the secondary battery is charged to 4.25V and then discharged to 2.5V at 0.33C. The expression “unit capacity” means 1 Ah. The parameter W may have the unit of g/Ah (gram per ampere hour). The parameter S may have the unit of m2 (square meter). The quotient W/S may have the unit of (g/Ah)·m⁻².

The W may be about 2.2 g/Ah or less, preferably about 1.5 g/Ah to about 2.2 g/Ah, and more preferably about 1.7 g/Ah to about 2.2 g/Ah, and the S may be about 0.02m² to about 0.09 m², preferably about 0.03 m² to about 0.08 m², and more preferably about 0.03m² to about 0.75m².

Herein, the total weight of electrolyte in the secondary battery refers to an amount of electrolyte remaining in the secondary battery after an activation process. Thus, the total weight of the electrolyte may indicate a weight of the electrolyte that is present in the secondary battery after completing production or during operation. For the sake of simplicity, the total weight of the electrolyte may be used herein interchangeably with a (total) amount of the electrolyte.

The W/S may be 0.1 (g/Ah)·m⁻² to 42 (g/Ah)·m⁻², 1 (g/Ah)·m⁻² to 42 (g/Ah)·m⁻², 5 (g/Ah)·m² to 42 (g/Ah)·m⁻², 10 (g/Ah)·m⁻² to 42 (g/Ah)·m⁻², or 20 (g/Ah)·m⁻² to 42 (g/Ah)·m⁻², without being limited thereto. In a specific example, the W/S may be 30 (g/Ah)·m⁻² to 42 (g/Ah)·m⁻².

A secondary battery may be manufactured by preparing a respective electrode active material slurry and applying it to a positive electrode collector and a negative electrode collector, thereby obtaining a positive electrode and a negative electrode. One or more layers of the positive electrode, one or more layers of a separator are stacked upon each other in a manner that the separator interposes between a layer of the positive electrode and a layer of the negative electrode, thereby obtaining an electrode assembly. The electrode assembly is accommodated in a battery case, which may be a pouch, a cylindrical can or a polyhedric can, and an electrolyte is injected into the battery case.

A pouch-type secondary battery may be manufactured by a press processing on a pouch film stack to form a cup part specifically configured (e.g., shaped and dimensioned) so as to accommodate the electrode assembly. After arranging the electrode assembly in the cup part, an electrolyte may be added to the electrode assembly, and the pouch film stack may be sealed along a sealing part thereof. A can-type secondary battery may be manufactured by accommodating an electrode assembly in a can made of a metal material, injecting an electrolyte into the can, and sealing the can by mounting a cap on an opening of the can. As mentioned, the can may have a cylindrical shape or a polyhedric shape, for example a (rectangular) cuboid or a rhombus.

The electrolyte of the secondary battery may be provided as described in detail below. The electrode assembly of the secondary battery may be provided as described in detail below. The battery case of the secondary battery may be a pouch, which may be used herein in accordance with the understanding in the art of designing and manufacturing secondary batteries. Alternatively, the battery case of the secondary battery may be a can as described herein. In particular, the electrolyte may be provided at least partly between the electrode assembly and an inner surface of the battery case facing the electrode assembly.

Particularly in a pouch-type secondary battery, the electrode assembly may have a rectangular shape, in a plan view, elongated in a longitudinal direction, which may be referred to herein as a length direction. The length as used herein may be measured in the length direction, unless indicated otherwise. A width direction of the electrode assembly indicates a direction that is perpendicular to the length direction and lies in the plane of at least one of the layer(s) of the positive electrode, the layer(s) of the negative electrode and the separator(s). The width as used herein may be measured in the width direction, unless indicated otherwise. In the electrode assembly, the layer(s) of the positive electrode, the layer(s) of the negative electrode and the separator(s) may be stacked in a thickness direction that is perpendicular to both the length direction and the width direction. Herein, the plan view may refer to a viewing direction parallel to the thickness direction of the electrode assembly.

In case of a can-type secondary battery, the electrode assembly as described above may be wound along a winding axis parallel to either the length direction or the width direction. Accordingly, the respectively other one of the length direction and the width direction, which is not parallel to the winding axis, may be parallel to a circumferential direction of the electrode assembly. In case of a can-type secondary battery, the length may refer to the length in the direction of the winding axis in the wound state and the width refers to the length in the direction perpendicular to the winding axis in the wound state.

The battery case may be a pouch, which may be provided in any of the manner disclosed herein. In particular, the pouch may be formed by pressing at least one cup part into a pouch film stack. Accordingly, the cup part may be formed as a planar portion protruding outwardly from the rest of the pouch film stack. The cup part may have a tray-like shape. The cup part may have a planar main surface surrounded by one or more sidewalls that are integral with the rest of the pouch film stack. The planar main surface of the cup part may have a rectangular basic shape in the plan view, whereby the corners may be rounded due to processing requirements or by design. The pouch may implement any, some or all of the features of the pouch as disclosed herein, unless indicated otherwise or technically inappropriate.

In a specific example, the battery case may be a pouch made of a pouch film stack. The pouch, in particular the pouch film stack, may comprise a barrier layer, a base material layer and a sealant layer. The base material layer may be disposed on one surface of the barrier layer, and the sealant layer may be disposed on the other surface of the barrier layer (i.e., opposite to the base material layer). In some examples, the base material layer, the barrier layer and the sealant layer may form the pouch film stack, particularly a laminate structure. The pouch, particularly the pouch film stack thereof, may be press-formed (particularly stretch-formed and/or drawn) such as to have one or more cup parts protruding outwardly (from the rest of the pouch, or the rest of the pouch film stack). The electrode assembly may be accommodated in the one or more cup parts. The one or more cup parts may be shaped and dimensioned so as to accommodate the electrode assembly. The components of the pouch may each implement any, some or all of the respective features as disclosed herein, unless indicated otherwise or technically inappropriate. In particular, any of the base material layer, the barrier layer and the sealant layer may be implemented as respectively described in detail below.

The battery case may be a pouch.

The battery case may be formed by pressing at least one cup part into a pouch film stack, and the pouch stack film may include a barrier layer, a base material disposed on an outer surface of the barrier layer, and a sealant layer disposed on an inner surface of the barrier layer.A frictional force between the electrode assembly and an inner surface of the battery case may be about 15 kgf or more.

The secondary battery may have a rated capacity of about 50 Ah to about 200 Ah, preferably about 50 Ah to about 150 Ah, and more preferably about 60 Ah to about 140 Ah.

The electrode assembly may have a substantially rectangular shape in the plan view such that a ratio of a length to a width of the electrode assembly ranges between 2.5 to 20, or between 3 to 15, or between 5 and 10. The specific aspect ratio of the electrode assembly may further contribute to increasing the aforementioned friction without increasing the need for electrolyte.

The electrode assembly may have a length of 200 mm to 800 mm and a width of 40 mm to 200 mm. The electrode assembly may have a length of 400 mm to 600 mm and a width of 50 mm to 150 mm. Preferably, the electrode assembly may have a length of 500 mm to 600 mm and a width of 50 mm to 100 mm. The specific combination of the length and width of the electrode assembly may further contribute to increasing the friction as discussed above, without increasing the need for electrolyte. The length and the width may each refer to a maximum extension of the electrode assembly in the length direction and the width direction, respectively, in the plan view. To emphasize this aspect, the term length may be used herein interchangeably with a “full length”. For a similar reason, the term width may be used herein interchangeably with a “full width”.

Meanwhile, the weight of the electrode assembly may be 500 g to 1500 g, preferably 550 g to 1450 g, and more preferably 600 g to 1400 g. When the weight of the electrode assembly satisfies the above range, high capacity can be realized, and friction between the electrode assembly and the inner surface of the battery case increases, resulting in excellent impact resistance.

Meanwhile, the secondary battery may further include at least one fixing member fixed to the outer surface of the electrode assembly by wrapping the electrode assembly in the width direction. In this case, the contact area between the fixing member and the electrode assembly may be 30% or less, 0 to 30%, 1 to 30%, 5 to 30%, 5 to 25%, or 5 to 20% of the total surface area of the electrode assembly. Since the fixing member is generally made of a material with a low coefficient of friction, when the area of the fixing member increases, the friction between the electrode assembly and the inner surface e of the battery case may decrease. Therefore, when using a fixing member, it is desirable to suppress a decrease in friction force by setting the contact area between electrode assemblies to 30% or less.

A frictional force between the electrode assembly and an inner surface of the battery case may be 15 kgf or more, preferably 15 kgf to 40 kgf, more preferably 17 kgf to 35 kgf. The frictional force between the inner surface of the battery case and the electrode assembly of a secondary battery may be determined as follows. A portion of the battery case was open by cutting; a positive electrode tab was held with a zig connected to a wire; the wire was connected to a universal testing machine (UTM); a force applied while pulling the wire at 100 mm/min is measured to determine the frictional force between the electrode assembly and the inner surface of the battery case.

When a crash shock test is performed on the secondary battery under a 133.7 G×15.8 m·s crash condition, leakage of the electrolyte may be zero. The crash shock test was performed under a 133.7 G×15.8 m·s crash condition. After the crash shock test, the battery case is examined for a loss of weight of the electrolyte due to leakage from the battery case and for a displacement of the electrode assembly within or out of the battery case.

In specific examples, the electrode assembly may have a length of 0.2 m to 0.8 m, a width of 0.05 m to 0.15 m, a weight of the electrolyte per unit capacity of 1.0 to 2.8 g/Ah. Such examples may achieve a quotient W/S of 30 (g/Ah)·m⁻² to 42 (g/Ah)·m⁻².

In further specific examples, the electrode assembly may have a length of 0.3 m to 0.8 m, a width of 0.06 m to 0.12 m, a weight of the electrolyte per unit capacity of 1.2 to 2.5 g/Ah. Such examples may achieve a quotient W/S of 30 (g/Ah)·m⁻² to 42 (g/Ah)·m⁻².

In further specific examples, the electrode assembly may have a length of 0.4 m to 0.6 m, a width of 0.07 m to 0.11 m, a weight of the electrolyte per unit capacity of 1.5 to 2.4 g/Ah. Such examples may achieve a quotient W/S of 30 (g/Ah)·m⁻² to 42 (g/Ah)·m².

According to another aspect, a secondary battery may be provided that comprises an electrode assembly, an electrolyte and a battery case. The electrode assembly may have a surface area of 0.01 to 0.2 m². The electrolyte may be provided with a total weight of 440 g or less. The battery case may accommodate the electrode assembly and the electrolyte. The electrode assembly, the electrolyte and the battery case may be configured such that a frictional force between the electrode assembly and an inner surface of the battery case is 15 kgf or more.

In particular, the surface area of the electrode assembly may be the product of the length and width of the same, provided that the electrode assembly has a rectangular shape as described above. The surface area of the electrode assembly may be 0.02 m² to 0.08 m², or 0.03 m² to 0.07 m², or 0.04 m² to 0.06 m².

As mentioned above, the total weight of the electrolyte indicates a weight of the electrolyte that is present in the secondary battery. For the sake of simplicity, the total weight of the electrolyte may be used herein interchangeably with a (total) amount of the electrolyte.

In addition, the secondary battery of this aspect may implement any, some or all of the features of the secondary battery and its components as disclosed herein. A repetition of all the features is omitted for the sake of conciseness and readability. Also, the secondary battery as described above may implement any, some or all of the features described with respect to the secondary battery of the latter aspect.

When a crash shock test is performed on the secondary battery under a 133.7 G×15.8 ms crash condition, leakage of the electrolyte may be zero.

The battery case may be a can-type battery case or a prismatic-type battery case.

In another aspect of the present disclosure, a secondary battery, includes a battery case defining an accommodation part accommodating an electrode assembly and an electrolyte, wherein the secondary battery satisfies following Equation (1). Equation (1): W/S is in a range of about 35 to about 42, where, in Equation (1), W is an amount of electrolyte per unit capacity of the secondary battery [unit: g/Ah], and S is a product of a total length [unit: m] and a full width [unit: m] of the electrode assembly.

The battery case may be a pouch.

The pouch may include a first cup and a second cup disposed on opposite sides of a folding part.

The W in Equation (1) may be in a range of about 1.5 g/Ah to about 2.2 g/Ah.

The S in Equation (1) may be in a range of about 0.02 m² to about 0.09 m².

A ratio of full length to full width of the electrode assembly may be in a range of about 5 to about 10.

The battery case may be a can-type battery case or a prismatic-type battery case.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is an exploded perspective view of a secondary battery according to an embodiment of the prevent disclosure; and

FIG. 2 is a cross-sectional view of a pouch film stack.

### DETAILED DESCRIPTION OF THE PREFERRED EMBODIMENT

Hereinafter, the present disclosure will be described in detail with reference to the accompanying drawings so that those of ordinary skill in the art can easily carry out the present disclosure. However, the disclosure may be implemented in different forms and is not limited or restricted by the following examples.

As the demand for high-capacity batteries, such as batteries for electric vehicles increases, the size and weight of electrode assemblies has increased to meet the high-capacity demand. However, when an external occurs, such as when the electric vehicle crashes, the battery case is susceptible to damage. Put differently, the larger and heavier electrode assembly may penetrate the battery case when the electrode assembly is forcibly displaced into the battery case. This phenomenon is particularly serious in a pouch-type batteries because of pouch-type cases have lower rigidity than prismatic-type cases. If the battery case is damaged, an electrolyte may leak, or the electrode assembly may be deformed, resulting in a fire, an explosion, or other serious limitations in battery performance and safety.

To alleviate the concern, in which the electrode assembly will be displaced from its original position to forcibly contact and damage/penetrate the battery case, the cross-sectional area of the electrode assembly and the content of the electrolyte may be designed to satisfy specific conditions. That is, the frictional force between the electrode assembly and the battery case may be increased compared to the related art to limit such displacement and reduce the force in which the electrode assembly contacts the battery case. As a result, when an external impact is applied, separation of the electrode assembly and/or leakage of the electrolyte is suppressed.

More particularly, a secondary battery according to the present disclosure may include a battery case having an accommodation part; and an electrode assembly and the electrolyte accommodated in the accommodation part, such that the following Equation (1) is satisfied.

$$W / S \leq 42 \qquad Equation ( 1 )$$

Where W/S in Equation 1 may have a dimension of (g/Ah)·m⁻².

W may represent an weight of electrolyte per unit capacity of the secondary battery and may be measured by dividing an amount of electrolyte (unit: g) in the secondary battery by a rated capacity (unit: Ah) of the secondary battery, and S is a product of a total length [unit: m] and a full width [unit: m] of the electrode assembly. The weight of electrolyte in the secondary battery may refer to an amount of electrolyte remaining in the secondary battery after an activation process.

W/S may preferably be about 30 (g/Ah)·m⁻² to about 42 (g/Ah)·m⁻², and more preferably about 35 (g/Ah)·m⁻² to about 42 (g/Ah)·m⁻². When W/S is about 42 (g/Ah)·m⁻² or less, the frictional force between the electrode assembly and an inner surface of the battery case (e.g., a bottom surface of a cup part of the pouch) that is in contact with the electrode assembly may be greatly increased. As a result, when an external impact is applied, the electrode assembly is displaced with less force (if at all), to minimize separation of the electrode assembly and to prevent or minimize damage of the battery case, and in turn, leakage of the electrolyte.

The W may vary depending on the size of the electrode assembly, but may be, for example, about 2.2 g/Ah or less, preferably about 1.5 g/Ah to about 2.2 g/Ah, and more preferably about 1.7 g/Ah to about 2.2 g/Ah. If the W is too large, an effect of increasing frictional force between the electrode assembly and the inner surface of the battery case may be insignificant, and if the W is too small, battery performance may be deteriorated due as a result of there being insufficient electrolyte when the battery is driven.

The S may be a cross-sectional area of the electrode assembly and may be a value obtained by multiplying a full length and a full width of the electrode assembly. Here, the full length and the full width may use values measured in m units.

The S may be, for example, about 0.02 m² to about 0.09 m², preferably about 0.03 m² to about 0.08 m², and more preferably about 0.03 m² to about 0.75 m². If the S is too small, the battery capacity may be too low, and the effect of increasing the in frictional force may be insignificant. On the other hand, if S is too large, there is a risk that the case will be damaged upon external impact.

The secondary battery may have a rated capacity of about 50 Ah to about 200 Ah, preferably about 50 Ah to about 150 Ah, and more preferably about 60 Ah to about 140 Ah. When the rated capacity of the secondary battery satisfies the above range, a high-capacity secondary battery may be implemented.

In some examples, the secondary battery may be a pouch-type secondary battery. In these examples, the battery case may be a pouch including, for example, a barrier layer, a base material layer disposed on one surface of the barrier layer, and a sealant layer disposed on the other surface of the barrier layer. The pouch may also include at least one or more cup parts recessed in one direction, and an electrode assembly and an electrolyte accommodated in the cup part of the pouch.

When the conditions of Equation (1) are satisfied, the frictional force between the electrode assembly and the bottom surface of the pouch, specifically the cup part, may be greater than about 15 kgf, preferably about 15 kgf to about 40 kgf, and more preferably about 17 kgf to about 35 kgf to minimize displacement of the electrode assembly upon external impact. As a result, when the conditions of Equation (1) are satisfied, damage of the pouch is minimized, and the impact resistance of the pouch may be improved.

Here, the frictional force between the electrode assembly and the bottom surface of the pouch cup may be measured by the following method.

First, a portion of the pouch of the secondary battery may be open by cutting, a positive electrode tab may be held with a zig connected to a wire, the wire may be connected to a universal testing machine (UTM). A force may then be applied while pulling the wire at a speed of about 100 mm/min to measured and evaluate frictional force between the electrode assembly and the bottom surface of the cup part.

The secondary battery according to the present invention may have high frictional force between the electrode assembly and the battery case to minimize separation of the electrode assembly from its original position on the bottom of the cup part when the external impact is applied As a result, when a crash shock test was performed on the secondary battery of the present disclosure, under a crash condition of about 133.7 G×15.8 ms, leakage of the electrolyte did not occur.

The crash shock test may be performed by mounting a battery to be measured on a jig of a drop impact device, and then, freely dropping the battery at a specific height to determine whether the battery is damaged. Here, the free drop height is set in consideration of a crash condition (acceleration×duration time) to be measured. Specifically, the free drop height may be set by converting impact energy under the crash condition to be measured into potential energy, and then calculating a height at which the converted potential energy is obtained in consideration of the weight of the battery to be measured. Whether the battery is damaged may be evaluated by a presence or absence of leakage of electrolyte.

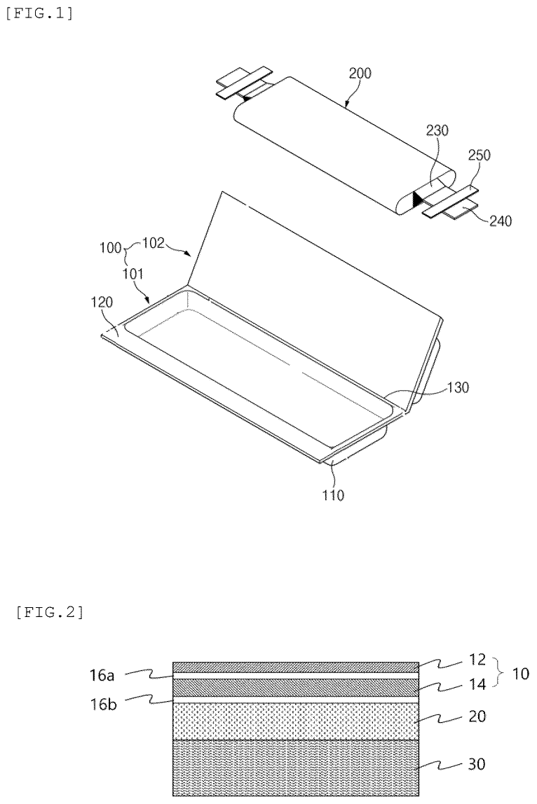

FIG. 1 is an exploded perspective view of a secondary battery according to an embodiment of the prevent disclosure, and FIG. 2 is a cross-sectional view of a pouch film stack. Hereinafter, the secondary battery according to an embodiment of the present disclosure will be described in more detail.

### Pouch

The pouch 100 may be a battery case including one or more cup parts (sometimes referred to herein as “the accommodation part”) recessed in one direction for accommodating an electrode assembly and an electrolyte. The pouch 100 may include a barrier layer 20, a base material layer 10 disposed on one surface of the barrier layer.

Specifically, the pouch 100 may have flexibility and may be manufactured through a method, in which a pouch film stack, formed by sequentially stacking the base material layer 10, the barrier layer 20, and the sealant layer 30, is inserted into a press molding device, and a pressure is applied to a partial area of the pouch film stack using a punch so that the pouch film stack is stretched to form the cup part.

### Base Material Layer

The base material layer 10 may be disposed on the outermost layer of the pouch and may be configured to protect the electrode assembly upon an external impact and electrically insulate the electrode assembly.

The base material layer 10 may be made of a polymer material, for example, made of at least one polymer material selected from the group of polyethylene, polypropylene, polycarbonate, polyethylene terephthalate, polyvinyl chloride, acrylic polymer, polyacrylonitrile, polyimide, polyamide, cellulose, aramid, nylon, polyester, polyparaphenylene benzobisoxazoles, polyarylates, and Teflon.

The base material layer 10 may have a single-layer structure or, as illustrated in FIG. 2, may have a multi-layer structure in which different polymer films 12 and 14 are stacked. When the base material layer 10 is a multi-layer structure, an adhesive layer 16a may be disposed between the polymer films, and/or an adhesive layer 16b disposed between the polymer film 14 and the barrier layer 20.

The base material layer 10 may have a total thickness of about 10 μm to about 60 μm, preferably about 20 μm to about 50 μm, and more preferably about 30 μm to about 50 μm. When the base material layer has the multi-layer structure, the thickness refers to a cumulative thickness of the polymer films 12 and 14 and the adhesive layers 16a and 16b. When the base material layer 10 satisfies the above range, durability, insulation, and moldability may be excellent. When the thickness of the base material layer is too thin, the durability may be reduced, and the base material layer is susceptible to damage during the molding process. When the thickness of the base material layer 10 is too thick, the moldability of the pouch film stack is reduced. Furthermore, as the thickness of the base material layer 10 increases, the overall thickness of the pouch increases, which in turn, reduces the battery accommodation space and the size of the electrode assembly that can be disposed therein, resulting in reducing energy density.

According to one embodiment, the base material layer 10 may have a stacked structure of a polyethylene terephthalate (PET) film (e.g., polymer film 12) and a nylon film (e.g., polymer film 14). Here, the nylon film may be disposed on a side of the barrier layer 20, that is, inside the barrier layer 20, and the polyethylene terephthalate film may be disposed on a surface side of the pouch.

Polyethylene terephthalate (PET) material has excellent durability and electrical insulation properties, and thus, when the PET film is placed on the surface side, the durability and insulation properties may be excellent. However, PET film may not securely adhere with an aluminum alloy constituting the barrier layer 20, and even when PET film is secured to the aluminum alloy, it may alter the stretching behavior of the pouch film stack. Consequently, during the molding process, the base material layer and the barrier layer may be peeled apart from one another, and/or the barrier layer may be non-uniformly stretched, resulting in deterioration of the moldability. In comparison, since nylon film has a stretching behavior similar to that of the aluminum alloy thin film constituting the barrier layer 20, disposing a nylon film between the polyethylene terephthalate and the barrier layer has the effect of improving the moldability of the pouch film stack.

The polyethylene terephthalate film may have a thickness of about 5 μm to about 20 μm, preferably about 5 μm to about 15 μm, and more preferably about 7 μm to about 15 μm. The nylon film may have a thickness of about 10 μm to about 40 μm, preferably about 10 μm to about 35 μm, and more preferably about 15 μm to about 25 μm. When the thicknesses of the polyethylene terephthalate film and the nylon film satisfy the above ranges, the moldability and rigidity after the molding may be excellent.

### Barrier Layer

The barrier layer 20 may be configured to secure mechanical strength of the pouch 100, block introduction and discharge of a gas or moisture outside the secondary battery, and prevent the electrolyte from leaking.

The barrier layer 20 may have a thickness of about 40 μm to about 100 μm, more preferably about 50 μm to about 80 μm, and more preferably about 60 μm to about 80 μm. When the thickness of the barrier layer satisfies the above range, the moldability may be improved to increase cup molding depth, while preventing or reducing cracks and/or pinholes during molding, even when two cups are molded. As a result, the barrier layer satisfying the above range has improved resistance to external stresses after molding.

The barrier layer 20 may be made of a metal material, and specifically, may be made of an aluminum alloy thin film.

The aluminum alloy thin film may include aluminum and a metal element in addition to the aluminum, for example, at least one metal element selected from the group of iron (Fe), copper (Cu), chromium (Cr), manganese (Mn), nickel (Ni), magnesium (Mg), zinc (Zn), or a combination thereof.

Preferably, the aluminum alloy thin film may have an iron (Fe) content of about 1.2 wt % to about 1.7 wt %, preferably about 1.3 wt % to about 1.7 wt %, and more preferably about 1.3 wt % to about 1.45 wt %. When the iron (F2) content in the aluminum alloy thin film satisfies the above range, an occurrence of the cracks or pinholes may be minimized even when the cup part is formed deeply.

### Sealant Layer

The sealant layer 30 may be bonded through thermal compression and be disposed at the innermost layer of the pouch film stack and configured to seal the pouch.

Since the sealant layer 30 is a surface that is in contact with the electrolyte and the electrode assembly after the pouch is molded, the sealant layer 30 may be formed of a material that exhibits excellent insulation and corrosion resistance. Also, since the inside of the sealant layer 30 has to be completely sealed to prevent leakage of the electrolyte, the sealant layer 30 may be formed of a material having high sealability.

The sealant layer 30 may be made of a polymer material, for example, made of at least one or more material selected from the group of polyethylene, polypropylene, polycarbonate, polyethylene terephthalate, polyvinyl chloride, acrylic polymer, polyacrylonitrile, polyimide, polyamide, cellulose, aramid, nylon, polyester, polyparaphenylene benzobisoxazoles, polyarylates, and Teflon and particularly preferable to include polypropylene (PP). These materials are examples of materials that exhibit excellent mechanical properties such as tensile strength, rigidity, surface hardness, abrasion resistance, and heat resistance, and chemical properties such as corrosion resistance.

More specifically, the sealant layer 30 may include polypropylene, cast polypropylene (CPP), acid modified polypropylene, a polypropylene-butylene-ethylene copolymer, or a combination thereof.

The sealant layer 30 may have a single-layer structure or a multi-layer structure including two or more layers made of different polymer materials.

The sealant layer may have a total cumulative thickness of about 60 μm to about 100 μm, preferably about 60 μm to about 90 μm, and more preferably about 70 μm to about 90 μm. If the thickness of the sealant layer is too thin, the sealing durability and insulating properties may be deteriorated. Alternatively, if the sealant layer is too thick, the flexibility may be deteriorated. Moreover, if the sealant layer is too thick, the total thickness of the pouch film stack may increase, which in turn, reduces the volume of the accommodation space and the size of the electrode assembly that may be disposed therein, resulting in a decrease in energy density volume.

The pouch film stack may be manufactured through any known process. For example, the pouch film stack may be manufactured through a process, in which the base material layer 10 is attached to a top surface of the barrier layer 20 through an adhesive, and the sealant layer 30 is formed on a bottom surface of the barrier layer 20 through co-extrusion or an adhesive, but is not limited thereto.

The pouch 100 may be manufactured by inserting the pouch film stack as described above into a molding device and applying pressure to an area of the pouch film stack using a punch to mold the cup part. Here, the pressure may be about 0.3 MPa to about 1 MPa, preferably about 0.3 MPa to about 0.8 MPa, more preferably about 0.4 MPa to about 0.6 MPa. If the pressure is too low during the molding of the cup part, excessive drawing may occur, and wrinkles may occur. On the other hand, if the pressure is too high, drawing may not be performed well, and the molding depth may be insufficient.

A moving speed of the punch may be about 20 mm/min to about 80 mm/min, preferably about 30 mm/min to about 70 mm/min, and more preferably about 40 mm/min to about 60 mm/min. If the pressure is too small, or the moving speed of the punch is too fast during the molding, wrinkles may occur due to buckling. Alternatively, if the pressure is too large, or the moving speed of the punch is too slow, stress may be concentrated into the cup part during the molding process, resulting in increases of occurrence of the pinholes or cracks.

The pouch 100 according to the present invention, which is manufactured through the above method, may include a lower case 101, an upper case 102, and a folding part 130 connecting the lower case to the lower case. Either one, or both, of the upper case or the lower case may include a recessed cup part 110.

Specifically, as illustrated in FIG. 1, the pouch 100 may have a cup shape in which the cup part 110 is formed in only the lower case 101, but the present disclosure is not limited thereto. For example, the pouch 100 may have a cup part formed on both the upper case and the lower cases. In the case of the 2-cup pouch, after accommodating the electrode assembly and the electrolyte, the upper case may be folded so that the cup part of the upper case and the cup part of the lower case face each other. As a result, the 2-cup pouch may be designed to accommodate thicker electrode assemblies, exhibiting higher energy density, than pouches having a single cup.

The cup part 110 may have an accommodation space for accommodating the electrode assembly 200. The pouch 100 may include a terrace 120 around the cup part 110. The terrace 120 may refer to a non-molded portion of the pouch film stack, that is, a remaining area except for the cup part 110. The terrace 120 may be a portion that is sealed through thermal bonding after accommodating the electrode assembly 200 in the cup part 110.

The cup part 110 may include a bottom surface and a circumferential surface. The circumferential surface may connect a bottom surface to the terrace 120. The circumferential surface may be provided in plurality, in more the detail, cup part 110 may include four circumferential surfaces. In this regard, when an electrode assembly 200 is disposed in the cup part 110, the bottom surface may cover one surface of the electrode assembly 200, and the circumferential surface may surround the lateral sides of the electrode assembly 200.

The folding part 130 may connect the lower case 101 to the upper case 102. After the electrode assembly 200 is accommodated in the cup part 110, the folding part 130 may then be folded to allow the upper case 102 to seal the cup part 110 of the lower case 101 and an electrolyte may be injected therein. When pouch 100 includes the folding part 130, the lower case 101 and the upper case 102 are integrally connected to each other along the folding part, thereby reducing the number of sides that need to be sealed. However, pouch 100 need not include folding part 130. Instead, lower case 101 and upper case 102 may be separately manufactured, and subsequently sealed during a sealing process.

When pouch 100 includes folding part 130, the folding part 130 is spaced apart from the cup part 110. More specifically, the folding part 130 may be apart from the folding part 130 by a distance of about 0.5 mm to about 3 mm, and preferably about 0.5 mm to about 2 mm. If the folding part 130 is provided too close to the cup part 110, folding may be inhibited. On the other hand, if the folding part 130 is provided too far from the cup part 110, a total volume of the secondary battery may increase, and the energy density versus the volume of the secondary battery may decrease. In the case of the 2-cup case, the folding part 130 may be spaced a distance from each cup part to satisfy the above-described distances.

### Electrode Assembly

The electrode assembly 200 may include a plurality of electrodes and a plurality of separators, which are alternately stacked. The plurality of electrodes includes a positive electrode and a negative electrode, which are alternately stacked with the separator therebetween.

In addition, the electrode assembly 200 may include a plurality of electrode tabs 230 that are welded to each other. Each of the plurality of electrode tabs 230 may be connected to a respective one of the plurality of electrodes 210 and protrude from the electrode assembly 200 to serve as a passage through which electrons move between the inside and the outside of the electrode assembly 200. The plurality of electrode tabs 230 may be disposed inside the pouch 100.

As shown in FIG. 1, the electrode tab 230 connected to the positive electrode and the electrode tab 230 connected to the negative electrode may protrude in opposite directions with respect to the electrode assembly 200. However, the present invention is not limited thereto. For example, the electrode tab 230 connected to the positive electrode and the electrode tab 230 connected to the negative electrode may protrude from the same side of the electrode assembly 200 and in the same direction such that the electrode tab 230 connected to the positive electrode and the electrode tab 230 connected to the negative electrode are parallel with each other.

A lead 240 supplying electricity to the outside of the secondary battery may be connected to the plurality of electrode tabs 230 by spot welding or the like. The lead 240 may have one end connected to the plurality of electrode tabs 230 and the other end protruding to the outside of the pouch 100.

A portion of the lead 240 may be surrounded by an insulating part 250. For example, the insulating part 250 may include an insulating tape. The insulating part 250 may be disposed between the terrace 120 of the second (upper) case 102 and the terrace 120 of the first (lower) case 101, and in this state, the terraces 120 of the first and second cases may be thermally fused to each other. As a result, a portion of each of the terrace 120 of first case 101 and a portion of the terrace 120 of the second case 102 may be thermally fused to the insulating part 250. Thus, the insulating part 250 may prevent electricity generated from the electrode assembly 200 from flowing into the pouch 100, via the lead 240, and may maintain the pouch 100 in a sealed state.

In one example, a ratio of the full length to the full width of the electrode assembly 200 may be about 5 to about 10, and preferably about 5 to about 8. When the ratio of the full length to the full width satisfies the above range, high energy density is realized in a limited space.

For example, the electrode assembly may have a full length of about 400 mm to about 600 mm, a full width of about 50 mm to about 150 mm, and preferably a full length of about 500 mm to about 600 mm, and a full width of about 50 mm to about 100 mm.

The weight of the electrode assembly may be 500 g to 1500 g, preferably 550 g to 1450 g, and more preferably 600 g to 1400 g, without being limited thereto. When the weight of the electrode assembly satisfies the above range, high capacity can be realized, and friction between the electrode assembly and the inner surface of the battery case increases, resulting in excellent impact resistance.

The secondary battery may further include at least one fixing member on the outer surface of the electrode assembly, if necessary. In the case of a rectangular electrode assembly (referred to as a ‘long-cell’ for convenience) whose length is longer than the width, fixing members are used to prevent the misalignment of the components of the electrode assembly such as the anode, cathode, and separator. The fixing member fix the electrode assembly by wrapping it in width direction.

The fixing member may include a porous structure. When the fixing member includes a porous structure, the electrolyte can pass through the fixing member and be impregnated into the electrode assembly, thereby preventing the electrolyte wetting property of the electrode assembly from being reduced due to the fixing member. Specifically, the fixing member may be a finishing tape with an adhesive layer formed on one side of a polymer base layer having a porous structure, but is not limited thereto. The polymer material may be, for example, polyethylene terephthalate (PET), polyvinyl chloride (PVC), polyethylene (PE), etc., but is not limited thereto.

The fixing member preferably has a width of approximately 10 to 50 mm or 20 to 40 mm along the full width direction of the electrode assembly. If the width of the fixing member is too wide, the outer surface area of the electrode assembly covered by the fixing member increases and thereby an electrolyte wetting property may reduce due to decreases of the contact area with the electrolyte and may decrease impact resistance due to decreases of the friction between the electrode assembly and the battery case. On the other hand, if the width of the fixing member is too thin, the effect of fixing the electrode assembly may be reduced.

The secondary battery may include 2 to 10 fixing members, preferably 2 to 8 fixing members, and more preferably 3 to 7 fixing members. At this time, the fixing members may be disposed in left and right symmetrical positions along the length direction, and preferably, the fixing members may be spaced apart at equal intervals. When a plurality of fixing members are provided and arranged as above, an electrode assembly having a long-cell structure with a long length can be firmly fixed.

Meanwhile, the contact area between the fixing member and the electrode assembly may be 30% or less, 25% or less, or 20% or less of the total surface area of the electrode assembly. Specifically, the contact area between the fixing member and the electrode assembly may be 0 to 30%, 1 to 30%, 5 to 30%, 5 to 25%, or 5 to 20% of the total surface area of the electrode assembly.

The contact area between the fixing member and the electrode assembly can be adjusted by adjusting the width or number of the fixing member used. Since the commonly used fixing member is made of a material with a lower friction coefficient than the separator disposed on the outermost surface of the electrode assembly. Accordingly, as the area of the fixing member surrounding the electrode assembly increases, the friction between the electrode assembly and the inner surface of the battery case will decrease. Therefore, when using a fixing member, it is desirable to suppress a decrease in friction force by setting the contact area between electrode assemblies to 30% or less.

### Electrolyte

The electrolyte may be configured to move lithium ions generated by an electrochemical reaction of the electrode during charging and discharging of the secondary battery and may include an organic solvent and lithium salt.

The organic solvent may be used without particular limitation as long as it serves as a medium through which ions involved in the electrochemical reaction of the battery move. Examples of the organic solvent may include ester solvents such as methyl acetate, ethyl acetate, γ-butyrolactone, and ε-caprolactone; ether solvents such as dibutyl ether or tetrahydrofuran; ketone solvents such as cyclohexanone; aromatic hydrocarbon solvents such as benzene and fluorobenzene; carbonate solvents such as dimethyl carbonate (DMC), diethyl (DEC), ethyl methyl carbonate (EMC), ethylene carbonate (EC), and propylene carbonate (PC); alcohol solvents such as ethyl alcohol and isopropyl alcohol; nitriles such as R-CN (R is a C2 to C20 straight-chain, branched or cyclic hydrocarbon group, and may include a double-bonded aromatic ring or an ether bond); amides such as dimethylformamide; dioxolanes such as 1,3-dioxolane; or sulfolanes. Among the above examples, carbonate-based solvents are preferable, and cyclic carbonates (e.g., ethylene carbonate or propylene carbonate, etc.) having high ionic conductivity and high permittivity that may increase charging and discharging performance of the battery, and low-viscosity linear carbonate-based compounds (e.g., mixture of ethyl methyl carbonate, dimethyl carbonate, or diethyl carbonate) are preferable.

Lithium salt may be used as long as it is a compound capable of providing lithium ions used in the lithium secondary battery. Specifically, the lithium salt may include LiPF₆, LiClO₄, LiAsF₆, LiBF₄, LiSbF₆, LiAlO₄, LiAlC₁₄, LiCF₃SO₃, LiC₄F₉SO₃, LiN(C₂F₅SO₃)₂, LiN(C₂F₅SO₂)₂, LiN(CF₃SO₂)₂, LiCl, LiI, or LiB(C₂O₄)₂, or the like. The concentration of the lithium salt may be preferably used within the range of about 0.1 M to about 5.0 M, and preferably about 0.1 M to about 3,0 M. When the concentration of the lithium salt is within the above range, the electrolyte has appropriate conductivity and viscosity, and thus, excellent electrolyte performance may be exhibited, allowing the lithium ions to move effectively.

In addition to the components of the electrolyte, the electrolyte may further include an adhesive for the purpose of improving lifespan characteristics of the battery, suppressing a decrease in battery capacity, and improving a discharge capacity of the battery.

Hereinafter, the present invention will be described in detail with reference to specific embodiments.

### Embodiment 1

A pouch 100 in which a cup part 110 was molded

from a pouch film stack. The pouch film includes stacked layers of nylon/polyethylene, terephthalate/Al alloy, and thin film/polypropylene. A stack-type electrode assembly 200 having a full length of about 548 mm, a full width of about 99 mm and a weight of 1380 g was accommodated in the cup part. Next, an electrolyte was injected, and the pouch was sealed, and then, an activation process was performed to manufacture a pouch-type secondary battery. Here, the electrolyte was injected so that a remaining amount of electrolyte per unit capacity after the activation process is about 2.2 g/Ah.

### Embodiment 2

A pouch-type secondary battery 100 was manufactured in the same manner as in Embodiment 1 except that the electrolyte is injected so that a remaining amount of electrolyte per unit capacity after the activation process is about 2.15 g/Ah.

### Embodiment 3

A pouch-type secondary battery 100 was manufactured in the same manner as in Embodiment 1 except that the stack-type electrode assembly 200 has a full length of about 548 mm, a full width of about 99 mm, and a weight of 641 g, and the electrolyte is injected so that a remaining amount of electrolyte per unit capacity after the activation process is about 1.7 g/Ah.

### Comparative Example 1

A pouch-type secondary battery was manufactured in the same manner as in Embodiment 1 except that a stack-type electrode assembly 200 having a full length of about 548 mm, a full width of about 99 mm and a weight of 641 g is used, and the electrolyte is injected so that a remaining amount of electrolyte per unit capacity after the activation process is about 2.2 g/Ah.

### Comparative Example 2

A pouch-type secondary battery was manufactured in the same manner as in Embodiment 1 except that the electrolyte is injected so that a remaining amount of electrolyte per unit capacity after the activation process is about 2.3 g/Ah.

### Experimental Example 1

### Friction Force Evaluation

The frictional force between the inner surface of the pouch cup part and the electrode assembly 200 was measured for each of the pouch-type secondary batteries prepared in Embodiments 1-3, and Comparative Examples 1 and 2, using the following method.

A portion of the pouch of the secondary battery was cut, a positive electrode tab was held with a zig connected to a wire, the wire was connected to a universal testing machine (UTM). Next, a pulling force was applied to the wire at a speed of about 100 mm/min to measure and evaluate the frictional force between the electrode assembly and the bottom surface of the cup part.

Results of the measurement are shown in Table 1 below.

### Experimental Example 2

### Crash Shock Test

A crash shock test was also performed on the pouch-type secondary batteries prepared in Embodiments 1-3 and Comparative Examples 1 and 2 under a 133.7 G×15.8 ms crash condition. Results of the measurement are also shown in Table 1 below. After the crash shock test, if leakage of the electrolyte and separation of the electrode assembly did not occur, the results were reported as “Pass,” and if leakage of the electrolyte and/or separation of the electrode occurred, the result was expressed as “Fail.”

TABLE 1

| | | | Remaining | | | |
|---|---|---|---|---|---|---|
| | | | amount of | | | |
| | | | electrolyte | | | Crash |
| | Full | Full | per unit | | Frictional | shock |
| | length | width | capacity | | force | test |
| Classification | [m] | [m] | [g/Ah] | W/S | [kgf] | result |
| Embodiment 1 | 0.548 | 0.099 | 2.2 | 40.6 | 17.5 | Pass |
| Embodiment 2 | 0.548 | 0.099 | 2.15 | 39.2 | 20.6 | Pass |
| Embodiment 3 | 0.548 | 0.078 | 1.7 | 39.8 | 32.4 | Pass |
| Comparative | 0.548 | 0.078 | 2.2 | 51.5 | 11.6 | Fail |
| Example 1 | | | | | | |
| Comparative | 0.548 | 0.099 | 2.3 | 42.4 | 11.4 | Fail |
| Example 2 | | | | | | |

As shown in [Table 1], each of the batteries according to Embodiments 1, 2, and 3, which have a W/S of less than 42, were graded as “pass.” The frictional force between the electrode assembly and the inner surface of the pouch was as high as about 15 kgf or more, and thus, separation of the electrode assembly due to an external impact was suppressed to exhibit excellent impact resistance. On the other hand, in the case of Comparative Examples 1 and 2, which have a W/S exceeding about 42, the frictional force was significantly reduced, and as a result, the leakage of the electrolyte occurred during the impact test and resulted in a grading of “fail.”

Thus, it can be seen, when the size of the electrode assembly and the amount of electrolyte per unit capacity satisfy the specific conditions outlined in this disclosure, the frictional force between the electrode assembly and the battery case may increase compared to the related art. As a result, when an external impact is applied, separation of the electrode assembly and/or the leakage of the electrolyte may be suppressed to implement the excellent impact resistance.

While the present invention has been shown and described in connection with the exemplary embodiments, it will be apparent to those skilled in the art that modifications and variations can be made without departing from the spirit and scope of the invention as defined by the appended claims.

What is claimed is:

1. A secondary battery comprising:
an electrode assembly;
an electrolyte;
a battery case accommodating the electrode assembly and the electrolyte,
wherein a ratio of full length to full width of the electrode assembly is in a range of 5 to 10,
wherein a weight of the electrolyte per unit capacity of the secondary battery is 1.0 to 2.8 g/Ah,
wherein the battery case is pouch or a polyhedric can, and
wherein frictional force between the electrode assembly and an inner surface of the battery case is 15 kgf or more.

2. The secondary battery of claim 1, wherein a surface area of the electrode assembly is 0.01 m² to 0.2 m².

3. The secondary battery of claim 1, wherein the weight of the electrolyte per unit capacity of the secondary battery is 1.5 to 2.4 g/Ah.

4. The secondary battery of claim 1, wherein the full length of the electrode assembly is 200 mm to 800 mm and the full width of the electrode assembly is 40 mm to 200 mm.

5. The secondary battery of claim 1, wherein, when a crash shock test is performed on the secondary battery under a 133.7 G×15.8 ms crash condition, a leakage amount of the electrolyte of the secondary battery is zero.

6. The secondary battery of claim 1, wherein a rated capacity of the secondary battery is in a ranges of 50 Ah to 200 Ah.

7. The secondary battery of claim 1, further comprising at least one fixing member fixed to the outer surface of the electrode assembly by wrapping the electrode assembly in the full width direction.

8. The secondary battery of claim 7, wherein the contact area between the fixing member and the electrode assembly is 30% or less of the total surface area of the electrode assembly.

9. The secondary battery of claim 1, wherein the weight of the electrode assembly is in range of 500 g to 1500 g.
